(19) United States
(12) Patent Application Publication
(10) Pub. No.: US 2024/0151073 A1
(43) Pub. Date: May 9, 2024

(54) LATCH WITH SECONDARY POSITION DETERMINED BY CINCH LEVER AND SUPPORTED BY PRIMARY PAWL

(71) Applicant: MAGNA CLOSURES INC., Newmarket (CA)

(72) Inventors: Ann-Margaret MOZOLA, Lakefield (CA); Roman CETNAR, Newmarket (CA); Francesco CUMBO, Pisa (IT)

(21) Appl. No.: 18/387,451

(22) Filed: Nov. 6, 2023

Related U.S. Application Data
(60) Provisional application No. 63/451,636, filed on Mar. 12, 2023.
(60) Provisional application No. 63/438,949, filed on Jan. 13, 2023.
(60) Provisional application No. 63/423,499, filed on Nov. 7, 2022.

(51) Int. Cl. E05B 81/22; E05B 81/06; E05B 81/36

(52) U.S. Cl. CPC E05B 81/22; E05B 81/06; E05B 81/36; E05B 83/36

(57) ABSTRACT

A latch assembly and system therewith configured for retaining a closure panel of a motor vehicle in a closed position relative to a vehicle body during and upon the latch assembly experiencing an impact force during a crash condition and/or a power shortage to the latch assembly and prior to the latch assembly having been intentionally actuated to move to an unlatched state.

### CROSS-REFERENCE TO RELATED APPLICATIONS

This application claims the benefit of U.S. Provisional Application Ser. No. 63/451,636, filed Mar. 12, 2023, of U.S. Provisional Application Ser. No. 63/438,949, filed Jan. 13, 2023, and of U.S. Provisional Application Ser. No. 63/423,499, filed Nov. 7, 2022, which are all incorporated herein by reference in their entirety.

### FIELD

The present disclosure relates generally to power door systems for motor vehicles. More particularly, the present disclosure is directed to a power door system equipped with a power latch assembly operable for powered holding and powered releasing of a ratchet relative to a pawl of the power latch assembly.

### BACKGROUND

This section provides background information related to the present disclosure which is not necessarily prior art.

In view of increased consumer demand for motor vehicles equipped with advanced comfort and convenience features, many current vehicles are now provided with power actuated latch assemblies operable via passive keyless entry systems to permit powered locking and powered release of the latch assembles without the use of traditional manual entry mechanisms. Although such power actuated latch assemblies provide desired functionality under normal operating conditions, further advancements are desired to ensure features of the power actuated latch assemblies retain their intended position and functionality upon being impacted, such as in a crash condition.

In view of the above, there remains a desire to develop alternative power door latch assemblies which address and overcome limitations associated with known power door latch assemblies to provide enhanced functionality upon being impacted and upon loss of power while minimizing cost and complexity associated with such advancements.

### SUMMARY

This section provides a general summary of the present disclosure and is not a comprehensive disclosure of its full scope or all of its features, aspects and objectives.

It is an aspect of the present disclosure to provide a latch assembly for selectively unlatching a vehicle closure panel for desired movement of the closure panel from a closed position to an open or deployed positions relative to a vehicle body when desired and for retaining the closure panel in a closed position and at least partially closed position relative to the vehicle body when desired.

It is a further aspect of the present disclosure to provide a latch assembly for retaining the closure panel in a closed position or an at least partially closed position relative to the vehicle body upon the power latch assembly experiencing an impact force during a crash condition and prior to the power latch assembly having been intentionally signaled to move to an unlatched state.

In accordance with these and other aspects, a power latch assembly for a motor vehicle having a vehicle body defining a door opening and a vehicle swing door pivotably connected to the vehicle body for swing movement along a swing path between open and closed positions relative to the door opening is provided. The power latch assembly of the present disclosure includes a power release actuator arranged to move a pawl from a ratchet holding position, whereat a ratchet is maintained in a striker capture position whereat the ratchet is in latched engagement with a striker to maintain the swing door in the closed position, to a ratchet releasing position, whereat the ratchet is moved to a striker release position out of latched engagement from the striker to allow the swing door to be moved from the closed position to the open position. The latch assembly includes a cinch mechanism that moves the ratchet from an at least partially released position to the striker capture positon. The latch assembly includes an auxiliary ratchet link that is aligned for engagement with the ratchet and the pawl to prevent inadvertent movement of the ratchet from the striker capture position to the striker releasing position upon the latch assembly having been impacted in a crash condition and/or upon loss of power to the power release actuator without first having been intentionally actuated to move to the ratchet releasing position.

In accordance with a further aspect, a method of controlling a power latch assembly includes: rotating a power release gear, using a motor, in a first direction away from a first home position to release the power latch assembly; ceasing rotation of the power release gear in the first direction following the power release gear reaching a second home position; rotating the power release gear using the motor in a second direction away from the second home position to cinch the power latch assembly; and ceasing rotation of the power release gear in the second direction following the power release gear reaching the first home position.

In accordance with a further aspect, the ceasing rotation of the power release gear in the first direction following the power release gear reaching a second home position is in response to detection of a stall condition of the motor, and wherein ceasing rotation of the power release gear in the second direction following the power release gear reaching the first home position is in response to detection of another stall condition of the motor.

In accordance with a further aspect, ceasing rotation of the power release gear does not occur between the first home position and the second home position.

In accordance with a further aspect, rotating the power release gear using the motor in a second direction away from the second home position to cinch the power latch assembly is in response to the ratchet being detected to have moved from an open position to a secondary striker capture position.

In accordance with a further aspect, during rotating the power release gear using the motor in a first direction away from a first home position to release the power latch assembly, the motor is adapted to cinch the power latch assembly to an overtravel position prior to the motor moving a pawl to a ratchet releasing position.

In accordance with a further aspect, during rotating the power release gear using the motor in a first direction away from a first home position to release the power latch assembly after the motor has moved pawl to the ratchet releasing position, the motor is adapted to resist the rotation of the ratchet towards a striker release position.

In accordance with a further aspect, a power latch assembly for a motor vehicle includes: a ratchet, a pawl, a cinch mechanism, and a single motor. The single motor is adapted to actuate the pawl to release the ratchet during the single motor rotating in a first direction during a power release cycle, and actuate the cinch mechanism to cinch the ratchet during the single motor rotating in a second direction during a power cinching cycle. The single motor is not actuated to change directions during either the power release cycle or during the power cinching cycle.

In accordance with a further aspect, a method of preventing a ratchet of a power latch assembly of a motor vehicle swing door from inadvertently moving from a striker capture position, whereat the ratchet is maintained in latched engagement with a striker to maintain the motor vehicle swing door in an at least partially closed position, to a striker release position, whereat the ratchet is moved out of latched engagement from the striker to allow the swing door to be moved from the closed position to the open position, during a crash condition of a motor vehicle is provided. The method includes: configuring an auxiliary ratchet link for engagement with the ratchet and a pawl to prevent inadvertent movement of the ratchet from the striker capture position to the striker release position upon the power latch assembly having been impacted in a crash condition and/or upon loss of power to the power release actuator without first having been intentionally actuated to move to the ratchet releasing position.

In accordance with a further aspect, a power latch assembly for a motor vehicle includes a power release actuator arranged to move a pawl from a ratchet holding position, whereat a ratchet is maintained in a striker capture position whereat the ratchet is in latched engagement with a striker to maintain a closure panel in a closed position, to a ratchet releasing position, whereat the ratchet is moved to a striker release position out of latched engagement from the striker to allow the closure panel to be moved from the closed position to the open position, and a cinch mechanism that moves the ratchet from an at least partially released position to the striker capture positon. A power release gear is configured to drive the pawl from the ratchet holding position to the ratchet releasing position, and to drive the ratchet from the at least partially released position to the striker capture positon during a cinching operation, and to place components of the power release actuator in a separate release position, and lock position. The power release gear does not have a single home position from which the power release gear moves to place the power release actuator in one of the separate release position and lock position.

In accordance with a further aspect, the power release gear establishes a home position at an end position (stop position without return to a start position) of performing a select one of a release, lock, and cinch actuation.

In accordance with a further aspect, the power release gear can move from the home position in opposite directions, depending on the location of the home position, to one of the release position and lock position, regardless of the position the power release gear starts from.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1A illustrates an example motor vehicle equipped with a power door actuation system situated between a front passenger swing door and a vehicle body and which is configured to include a power latch assembly in accordance with one aspect of the disclosure;

FIG. 1B is a partial perspective view showing the power latch assembly installed in a passenger swing door associated with the vehicle shown in FIG. 1A;

FIG. 2 is a partial perspective view of a power latch assembly constructed in accordance with an aspect of the disclosure with a ratchet shown in a striker release position;

FIG. 3 is front plan view of FIG. 2;

FIG. 4 is a view similar to FIG. 3, illustrating a striker initiating movement of the ratchet to a secondary striker holding position;

FIG. 5 is a view similar to FIG. 4, illustrating the ratchet in the secondary striker holding position;

FIG. 6 is a view similar to FIG. 5, illustrating initial movement of a cinch link to move the ratchet to a cinched position;

FIG. 7 is a view similar to FIG. 6, illustrating continued movement of the cinch link causing the ratchet to move toward the cinched position;

FIG. 8 is a view similar to FIG. 7, illustrating continued movement of the cinch link causing the ratchet to move toward the cinched position, with the ratchet shown in a primary striker capture position and a pawl shown in a primary ratchet holding position;

FIG. 9 is a view similar to FIG. 8, illustrating continued movement of the cinch link causing the ratchet to move to an overtravel position;

FIG. 10 is a view similar to FIG. 9, illustrating movement of the cinch link back toward a home position causing the ratchet to move to from the overtravel position back to the primary striker capture position;

FIG. 11 is a view similar to FIG. 10, illustrating continued movement of the cinch link back toward a home position out from engagement with a ratchet lever pin;

FIG. 11A is a view similar to FIG. 10, illustrating the cinch link maintained in close proximity to the ratchet lever pin or in coupled relation with ratchet lever pin;

FIG. 12 is a view similar to FIG. 3 illustrating the ratchet of the power latch assembly in the primary striker capture position;

FIG. 13 is a rear plan view illustrating a release mechanism of a power latch assembly constructed in accordance with an aspect of the disclosure;

FIGS. 13A and 13B are enlarged perspective of a release mechanism in accordance with an aspect of the disclosure;

FIG. 14 illustrates a front side plan view of a power latch assembly constructed in accordance with another aspect of the disclosure while in a fully closed position;

FIG. 15 illustrates a rear side plan view of the power latch assembly of FIG. 14;

FIG. 16 illustrates a perspective view of a ratchet of the power latch assembly of FIGS. 14 and 15;

FIG. 17 illustrates a perspective view of a pawl of the power latch assembly of FIGS. 14 and 15;

FIG. 18 illustrates a perspective view of a pawl lever of the power latch assembly of FIGS. 14 and 15;

FIGS. 19A and 19B illustrate opposite side views of a ratchet lever assembly of the power latch assembly of FIGS. 14 and 15;

FIGS. 20A and 20B illustrate opposite side views of a disengage lever assembly of the power latch assembly of FIGS. 14 and 15;

FIGS. 21A and 21B illustrate opposite side views of an actuator assembly of the power latch assembly of FIGS. 14 and 15;

FIG. 22 illustrates an auxiliary pawl release lever of the power latch assembly of FIGS. 14 and 15;

FIG. 23 illustrates an cinch link lever of the power latch assembly of FIGS. 14 and 15;

FIGS. 24A and 24B illustrate opposite side perspective views of the power latch assembly of FIGS. 16A and 16B while in the fully closed position, illustrating a cinch output being confronted by a cinch output stop to prevent movement of the ratchet from the primary striker capture position toward the striker release position while a power actuator of the power latch assembly is in a de-energized state;

FIG. 25 is a side plan view of FIG. 24B;

FIGS. 26A-45 illustrate a soft opening cycle of the power latch assembly of FIGS. 14 and 15;

FIGS. 46A-69 illustrate a cinching operation of the power latch assembly of FIGS. 14 and 15;

FIGS. 70A and 70B illustrate opposite side perspective views of the power latch assembly of FIGS. 14 and 15 while in a close position; and

FIG. 71 is a side plan view of the power latch assembly while in a closed position.

### DETAILED DESCRIPTION OF EXAMPLE EMBODIMENTS

In general, example embodiments of a power door actuation system including a power latch assembly constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

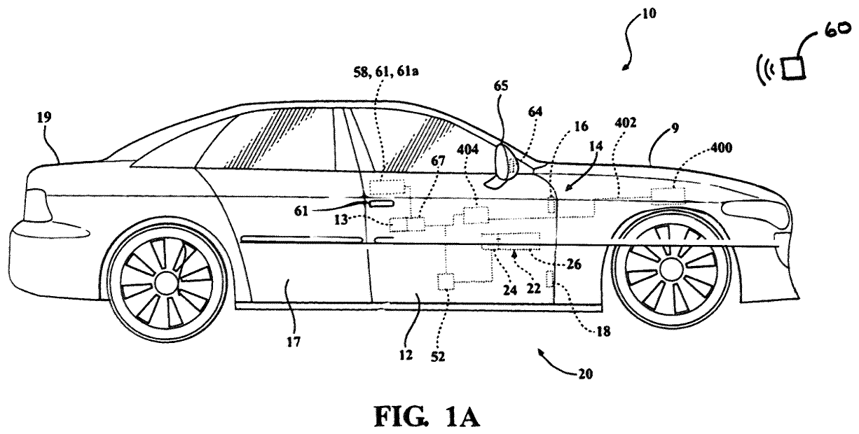

Referring initially to FIG. 1A, an example motor vehicle 10 is shown to include a first closure panel, shown by way of example and without limitation as a front passenger side door, referred to hereafter simply as swing door or door 12, pivotally mounted to a vehicle body 14 via an upper door hinge 16 and a lower door hinge 18 which are shown in dashed lines configured for a swinging motion about an hinge axis. In one possible application, the latch assembly may be used in a B-pillarless application. The latch assembly may be used in any application which requires power release, soft open and cinch. First closure panel may not be limited to swinging motion, but other types of motion, such as for example when side door motion is controlled by a powered 4 bar or sliding powered door in which the door is guided in opening and closing through a sliding track or 4 bar mechanism.

In accordance with the present disclosure, a power door actuation system 20 is associated with the swing door 12, and in accordance with a preferred configuration, power door actuation system 20 includes a power latch assembly 13, a vehicle door electric control unit (ECU) 52, and can also be configured with a power-operated swing door actuator 22 secured within an internal cavity of passenger door 12 for coordinated control of the opening and closing of the door 12, if desired. The motor vehicle 10 illustrated in FIG. 1A may be provided including mechanically actuatable outside vehicle door handles 61 and inside door handles 61a on the vehicle door 12. In accordance with an aspect of the disclosure, the power latch assembly 13 is configured to retain the swing door 12 in an at least partially closed position relative to the vehicle body 14 upon the vehicle body 14 and power latch assembly 13 experiencing an influence and or the power latch assembly 13 experiencing an inadvertent power interruption, such as for example an impact force during a crash condition, prior to the power latch assembly 13 having been intentionally signaled to move to an unlatched state. Accordingly, the power latch assembly 13 resists inadvertent, unintended opening of the swing door 12 upon experiencing an impact force, with the power latch assembly 13 being further configured to allow the swing door 12 to be intentionally opened subsequent to being impacted, as discussed in further detail below.

Each of upper door hinge 16 and lower door hinge 18 include a door-mounting hinge component and a body-mounted hinge component that are pivotably interconnected with one another by a hinge pin or post. While power door actuation system 20 is only shown in FIG. 1A in association with front passenger door 12, those skilled in the art will recognize that the power door actuation system 20 and power latch assembly 13 thereof can also be associated with any other door, such as rear passenger doors 17 as shown in FIG. 1B, or also be associated with other closure panels, such as a liftgate (not shown), a hood 9, or a decklid 19. Also, while the door 12 is illustrated herein as being pivotally mounted to the vehicle body 14 for rotation relative to a vertical or generally vertical axis extending through upper and lower hinges 16, 18, it may be configured for rotation about a horizontal axis as would be the case for a liftgate, or other offset (oblique) axis, or the like. For greater clarity, the vehicle body 14 is intended to include the ‘non-moving’ structural elements of the vehicle 10, such as the vehicle frame, structural support pillars and members, and body panels.

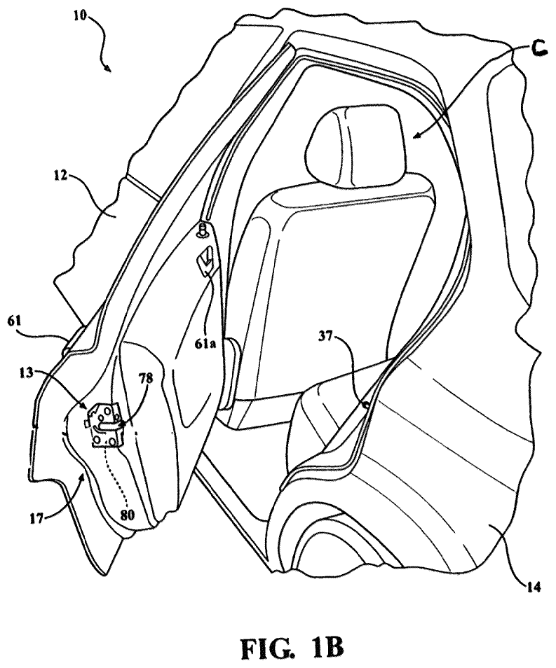

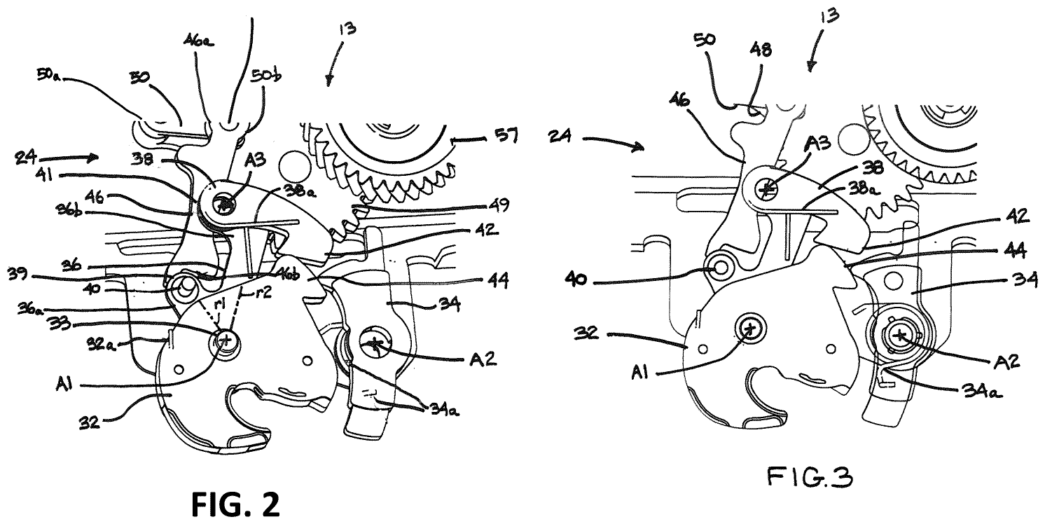

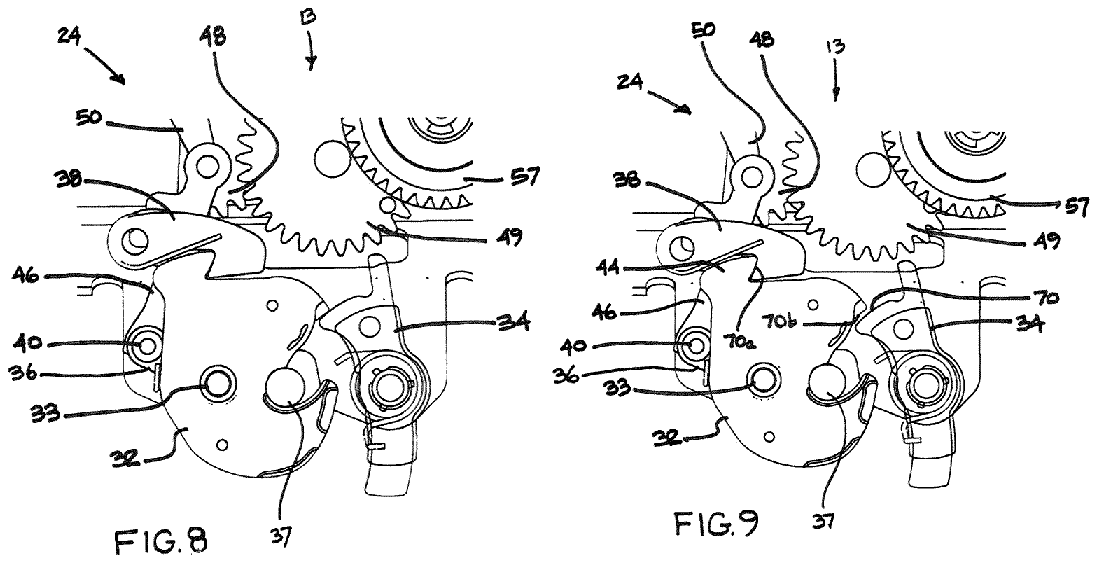

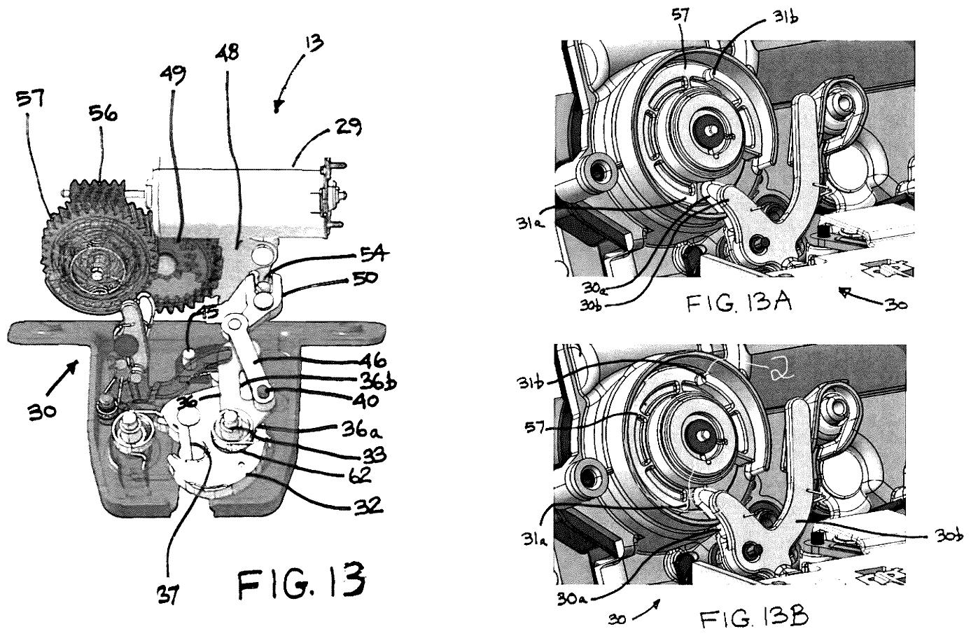

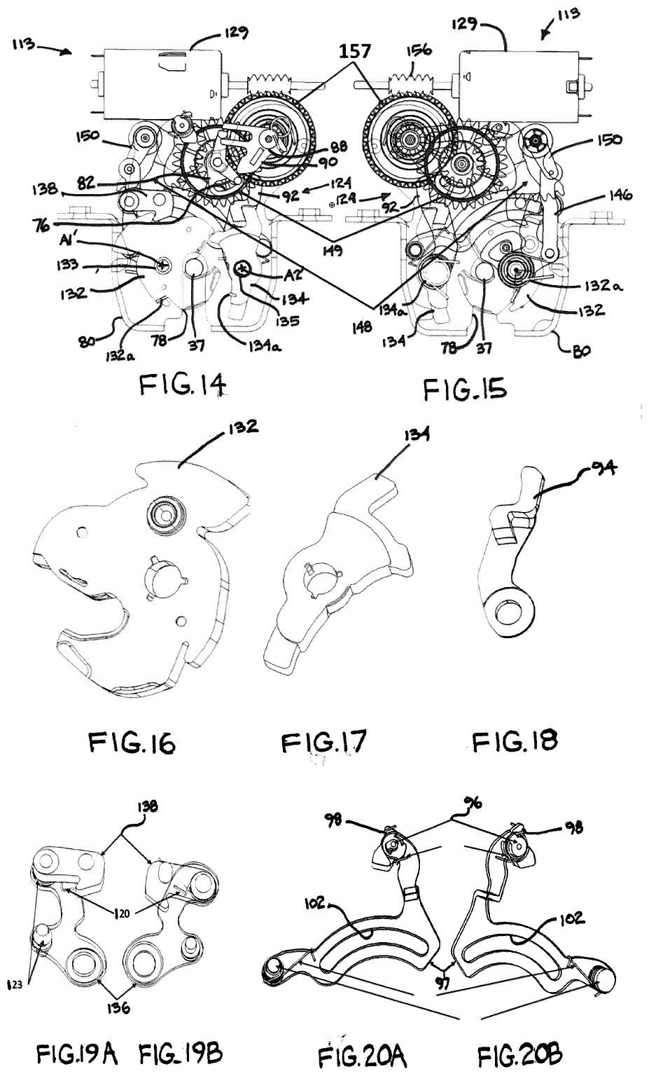

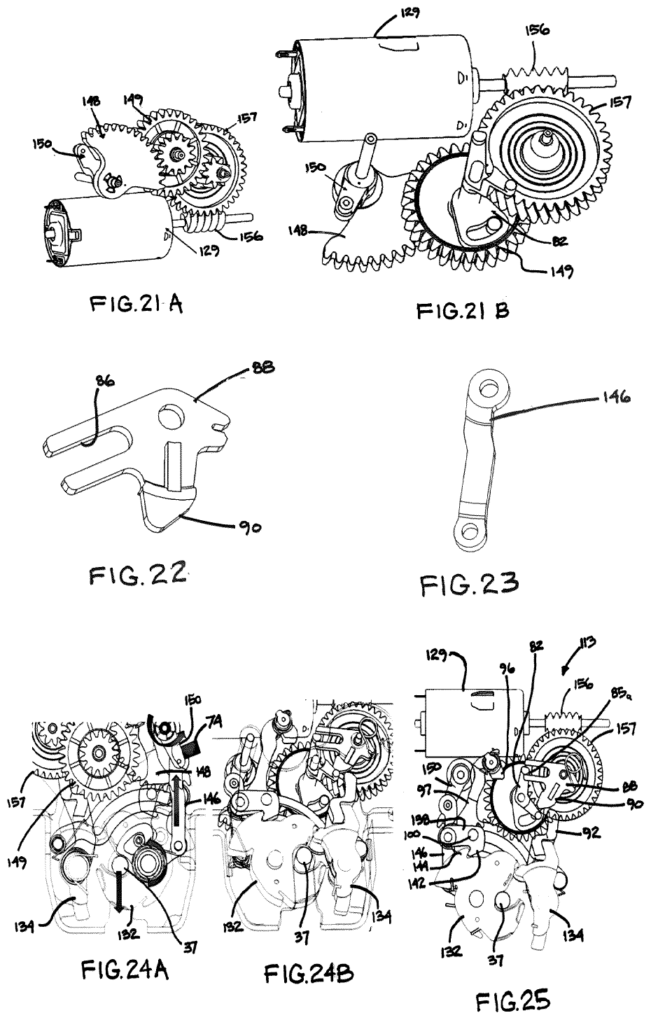

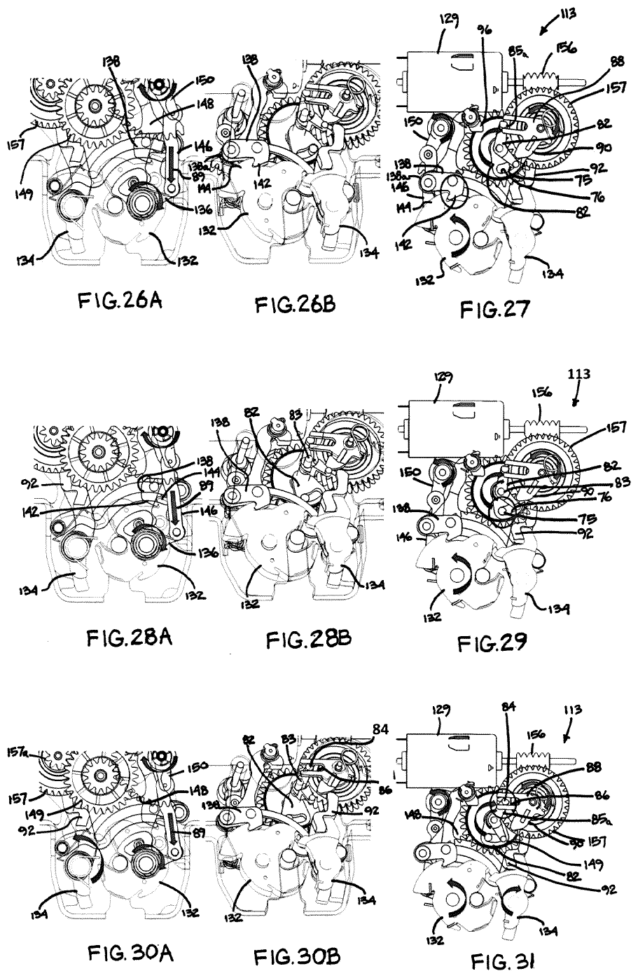

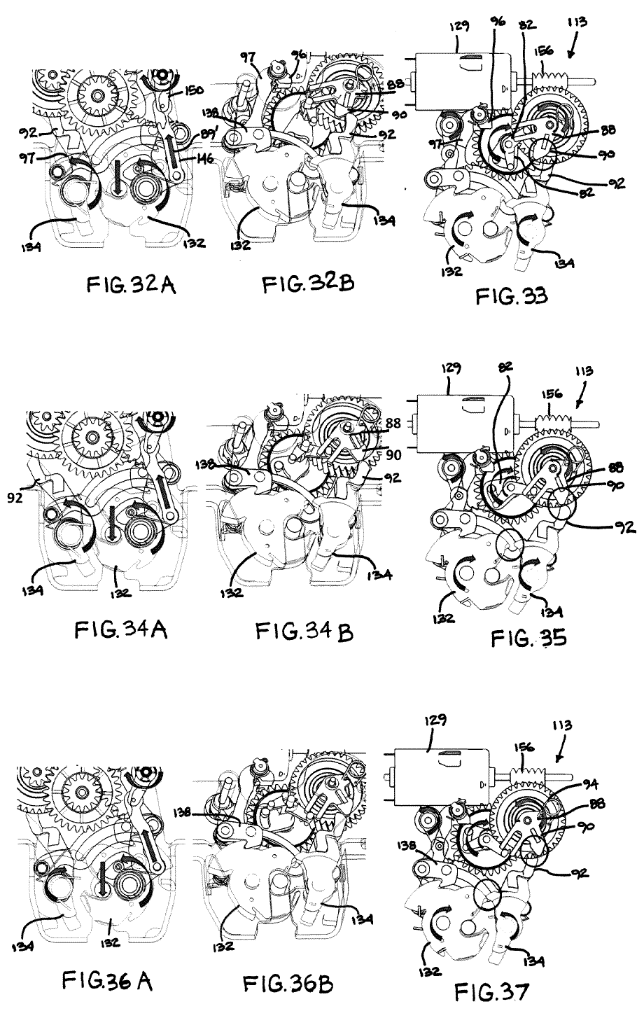

Referring to FIG. 1B, shown is a non-limiting embodiment of power latch assembly 13 for vehicle doors 12, 17 of vehicle 10. Power latch assembly 13 can be positioned on vehicle door(s) 12, 17 and arranged in a suitable orientation to engage and retain a striker 37, mounted on vehicle body 14, when door 12, 17 is closed. Power latch assembly 13 includes parts as enumerated in FIG. 2, and a power release actuator 29, such as an electric motor (FIG. 13), for controlling powered actuation of a latch release mechanism 24. Power latch assembly 13 includes a ratchet 32 that is moveable between two striker capture positions about a ratchet axis, referred to hereafter as axis A1, defined by a ratchet rivet, also referred to as ratchet pin 33. Ratchet 32 pivots about axis A1 between a primary or fully closed position (shown in FIGS. 10-13), also referred to as primary striker capture position or primary locking position, and a secondary or partially closed position (FIG. 5), also referred to as secondary striker capture position or secondary locking position, whereat ratchet 32 retains striker 37 against being fully released while in both positions. Ratchet 32 is also moveable to a striker release position (FIG. 3), whereat ratchet 32 permits release of striker 37 from a fishmouth 78 (FIG. 1B) provided by a latch housing, also referred to as frame plate 80, of power latch assembly 13. A ratchet biasing member 32a, such as a spring, is provided to normally bias ratchet 32 toward its striker release position, corresponding to a counterclockwise direction, as viewed in FIG. 2. A pawl 34 is movable about a pawl axis, referred to hereafter as axis A2, defined by a pawl rivet, also referred to as pawl pin 35 (FIG. 3). Pawl 34 pivots about axis A2 between at least one ratchet holding position (FIG. 9) whereat pawl 34 holds ratchet 32 in its closed, striker capture position(s), wherein swing door 12 is maintained in a closed state, also referred to as closed position, thereby being restrained against being fully opened, and a ratchet releasing position (FIG. 3) whereat pawl 34 permits ratchet 32 to move to its open, striker release position, wherein swing door 12 can be moved to a fully open state, also referred to as open position. A pawl/pawl release lever biasing member 34a, such as a suitable spring, is provided to normally bias pawl 34 toward its ratchet holding position.

Power release actuator 29 can be used as part of a conventional passive keyless entry feature. When a person approaches vehicle 10 with an electronic key fob 60 (shown schematically in FIG. 1A) and actuates the outside door handle 61, for example, sensing both the presence of key fob 60 and that outside door handle 61 has been actuated (e.g. via communication between a switch (not shown) and a latch electronic control unit (ECU) shown at 67 (FIG. 1A) that at least partially controls the operation of power latch assembly 13. In turn, latch ECU 67 signals and actuates power release actuator 29 to cause the latch release mechanism 24, via driven rotation of a power release gear 57 (FIG. 15) in an unlocking direction, to pivot pawl 34 to its ratchet releasing position to release ratchet 32 to move under the bias of ratchet biasing member 32a to its striker release position and shift power latch assembly 13 into an unlatched operating state so as to facilitate subsequent opening of swing door 12. Power release actuator 29 can be alternatively activated as part of a proximity sensor based entry feature (radar based proximity detection for example), for example when a person approaches vehicle 10 with an electronic key fob 60 and actuates a proximity sensor 58, such as a capacitive sensor, or other touch/touchless based sensor (based on a recognition of the proximity of an object, such as the touch/swipe/hover/gesture or a hand or finger, or the like), (e.g. via communication between the proximity sensor 58 (FIG. 1A) and latch ECU 67 (FIG. 1A) that at least partially controls the operation of closure latch assembly 13). In turn, latch ECU 67 signals power release actuator 29 to move and cause the latch release mechanism 24 to shift power latch assembly 13 into an unlatched operating state to facilitate subsequent opening of vehicle door 12. Also, power release actuator 29 can be used in coordinated operation with power-operated swing door actuator 22. Further yet, outside door handle 61 may be configured for mechanical actuation of power latch assembly 13 to facilitate opening the swing door 12, as will be understood by a person possessing ordinary skill in the art of latches, such as, by way of example and without limitation, during power interruption and/or upon experiencing a crash condition, as discussed further below.

The door 12 may have conventional opening lever or inside door handle 61ₐ located on an interior facing side of the door 12 facing the inside of the passenger compartment C for opening the door 12 (e.g. including unlocking and opening the power latch assembly 13, as well as commanding operation of the power-operated swing door actuator 22). This opening lever or inside door handle 61a can trigger a switch 63a connected operably to the latch ECU 67 such that, when the switch 63a is actuated, the latch ECU 67 signals and facilitates power latch assembly 13 being activated. Subsequently, the latch ECU 67 may facilitate that the power-operated swing door actuator 22 is activated (i.e. the extension member 26 is deployed or extended) to continue the automatic opening of the swing door 12. In the alternative, the power-operated swing door actuator 22 may be powered on at a point before the final presentment position is reached so as to provide a seamless transition between the two stages of door opening (i.e. both motors are overlapping in operation for a short time period). Alternatively, the latch ECU 67 may facilitate that the power-operated swing door actuator 22 is operated as a door check (i.e. the extension member 26 is deployed or extended and maintained at such a deployed or extended condition) until the user manually takes control of the swing door 12 to further open it to a fully opened position. Further yet, inside door handle 61a may be configured for mechanical actuation of power latch assembly 13, via intervening mechanical mechanism(s), to facilitate opening the swing door 12, as will be understood by a person possessing ordinary skill in the art of latches, such as during power interruption and/or upon experiencing a crash condition, as discussed further below.

Now referring back to FIG. 1A, the power door actuation system 20 and the power latch assembly 13 are electrically connected to a main power source 400 of the motor vehicle 10, for example a main battery providing a battery voltage V_{batt} of 12 V, through an electrical connection element 402, for example a power cable (the main power source 400 may equally include a different source of electrical energy within the motor vehicle 10, for example an alternator). The electronic latch ECU 67 and/or swing door ECU 52 are also coupled to the main power source 400 of the motor vehicle 10, so as to receive the battery voltage V_{batt}; the electronic latch ECU 67 and/or swing door ECU 52 are thus able to check if the value of the battery voltage V_{batt} decreases below a predetermined threshold value, to promptly determine if an emergency condition (when a backup energy source may be needed) occurs.

As shown in the schematic block diagram of FIG. 1A, a backup energy source 404, which may be integrated forming part of an electronic control circuit of the electronic latch ECU 67 and/or swing door ECU 52, or may be separate therefrom, is configured to supply electrical energy to the power door actuation system 20 and/or the power latch assembly 13, and to the same electronic control circuit of the electronic latch ECU 67 and/or swing door ECU 52, in case of failure or interruption of the main power supply from the main power source 400 of the motor vehicle 10.

In an illustrative example, the backup energy source 404 includes a group of low voltage supercapacitors (not shown) as an energy supply unit (or energy tank) to provide power backup to the power door actuation system 20 and/or the power latch assembly 13, even in case of power failures. Supercapacitors may include electrolytic double layer capacitors, pseudocapacitors or a combination thereof. Other electronic components and interconnections of a backup energy source 404, such as a boost module to increase the voltage from the backup energy source 404 to an actuator, such as the power-operated swing door actuator for example, are disclosed in co-owned patent application US2015/0330116, which is incorporated herein by way of reference in its entirety.

Swing door ECU 52 can also receive an additional input from a proximity sensor 64 (e.g. ultrasonic or radar) positioned on a portion of swing door 12, such as on a door mirror 65, or the like, as shown in FIG. 1A. Proximity sensor 64 assesses if an obstacle, such as another car, tree, post, or otherwise, is near or in close proximity to vehicle door 12. If such an obstacle is present, proximity sensor 64 will send a signal to swing door ECU 52, and swing door ECU 52 will proceed to turn off electric motor 24 to stop movement of swing door 12, and thus prevent vehicle door 12 from hitting the obstacle.

In FIG. 2, some of the components of power latch assembly 13 are shown. Power latch assembly 13, in accordance with an aspect of the disclosure, includes a ratchet lever 36 coupled for movement relative to ratchet 32, and shown as being coupled to the ratchet pin 33 for pivotal movement about axis A1. Ratchet lever 36 has a first arm 36a extending along a first radius r1 from axis A1 to a first arm end 39 and a second arm 36b extending along a second radius r2, different from first radius r1, from axis A2 to a second arm end 41, wherein first and second arms 36a, 36b are shown a defining a generally V-shaped valley therebetween. First radius r1 and second radius r2 are shown, by way of example and without limitation, as having an included angle therebetween that is an acute angle, and is further shown as being between about 10-60 degrees. A ratchet lever pin 40 extends outwardly from first arm 36a. Ratchet lever pin 40 is shown as extending from first arm 36a adjacent first arm end 39, with ratchet lever pin 40 extending generally transversely from a planar surface of first arm 36a and first radius r1. An auxiliary ratchet link 38 is coupled to ratchet lever 36 for movement between two positions about an auxiliary ratchet link axis, referred to hereafter as axis A3, defined by an auxiliary ratchet rivet, also referred to as auxiliary ratchet pin 45 (FIG. 15). An auxiliary ratchet link 38 is pivotal about axis A3 between a locking position, whereat a hook-shaped end, referred to hereafter as hook end 42, captures a ratchet tooth 44 extending radially outwardly from a main body of ratchet 32, and a release position, whereat hook end 42 is released from captured engagement with ratchet tooth 44, thereby allowing ratchet 32 to move under the bias of ratchet biasing member 32a to the striker release position. Auxiliary ratchet link 38 is biased toward its ratchet capture position by an auxiliary ratchet biasing member 38a, such as a torsion spring, by way of example and without limitation. As such, auxiliary ratchet link 38 is biased into engagement with an outer peripheral surface of ratchet 32 while in its release position, and is automatically biased into its locking position when the hook end 42 and the ratchet tooth 44 are misaligned radially from one another when ratchet 32 is moved to its secondary locking position, as discussed further below.

Power latch assembly 13 has a cinch mechanism including a cinch link 46 operably coupled to a cinch drive gear, referred to hereafter as cinch gear 48 (FIG. 13), with cinch gear 48 being configured for driven rotation in response to rotation of power release gear 57. In the non-limiting embodiment illustrated, cinch gear 48 is coupled to power release gear 57 via an intermediate gear 49, and cinch link 46 is coupled to cinch gear 48 via an intermediate connecting link, referred to as intermediate link 50. Intermediate link 50 has a first end 50a driven by a drive lug 54 fixed to cinch gear 48, wherein drive lug 54 can be formed as a monolithic piece of material with cinch gear 48, or formed as a separate piece of material and fixed to cinch gear 48, such as via a weld joint, for example. Intermediate link 50 has a second end 50b pivotably coupled to a first end 46a of cinch link 46, such as via a pin 55. Cinch link 46 has a second end 48b configured for driving engagement with ratchet lever pin 40 during a cinching operation, as discussed further below.

Power release actuator 29, upon being energized, drives a worm gear 56 configured in meshed engagement with power release gear 57, whereupon a first pinion gear 57a fixed to power release gear 57, and configured in meshed engagement with intermediate gear 49, drives intermediate gear 49, whereupon a second pinion gear 49a fixed to intermediate gear 49, and configured in meshed engagement with cinch gear 48, drives cinch gear 48, which causes drive lug 54 to pivot intermediate link 50 in the desire direction to effect the cinching and release process.

In FIG. 3, ratchet 32 is illustrated in its open, striker release position. In this position, the cinch link 36 is disengaged (spaced from or not applying force thereto) from the ratchet lever pin 40, the hook end 42 of the auxiliary ratchet link 38 is released from the ratchet tooth 44 of the ratchet 32, and biased into engagement with a peak of the ratchet tooth 44 via auxiliary ratchet biasing member 38a, and the pawl 34 is moved to the ratchet releasing position, and biased into engagement with the peak surface of the ratchet tooth 44 via pawl biasing member 34a. As such, the ratchet 32 is biased by the ratchet biasing member 32a to the striker release position.

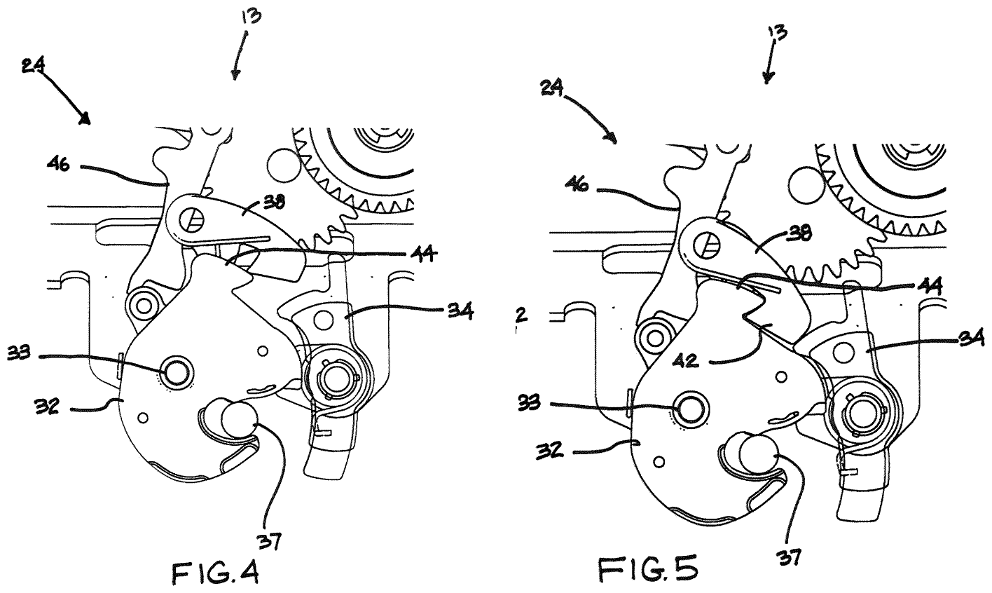

In FIG. 4, striker 37, which is fixed to door 12, is moved into engagement with ratchet 32, whereupon ratchet 32 pivots about axis A1 of ratchet pin 33 in a counterclockwise direction, as viewed in FIG. 4. Pawl 34 is moved off ratchet tooth 44 and biased into engagement with ratchet 32, and auxiliary ratchet link 38 slides along the peak of ratchet tooth 44.

In FIG. 5, ratchet 32 is moved to its secondary locking position under the forcible engagement by striker 37, whereat auxiliary ratchet link 38 is moved off the peak of ratchet tooth 44, with the hook end 42 being brought into hooked engagement with a secondary locking surface 70a ratchet tooth 44, and with and end of pawl 34 being brought into engagement with an end of auxiliary ratchet link 38. As such, the hook end 42 is sandwiched between ratchet hook 44 and pawl 34.

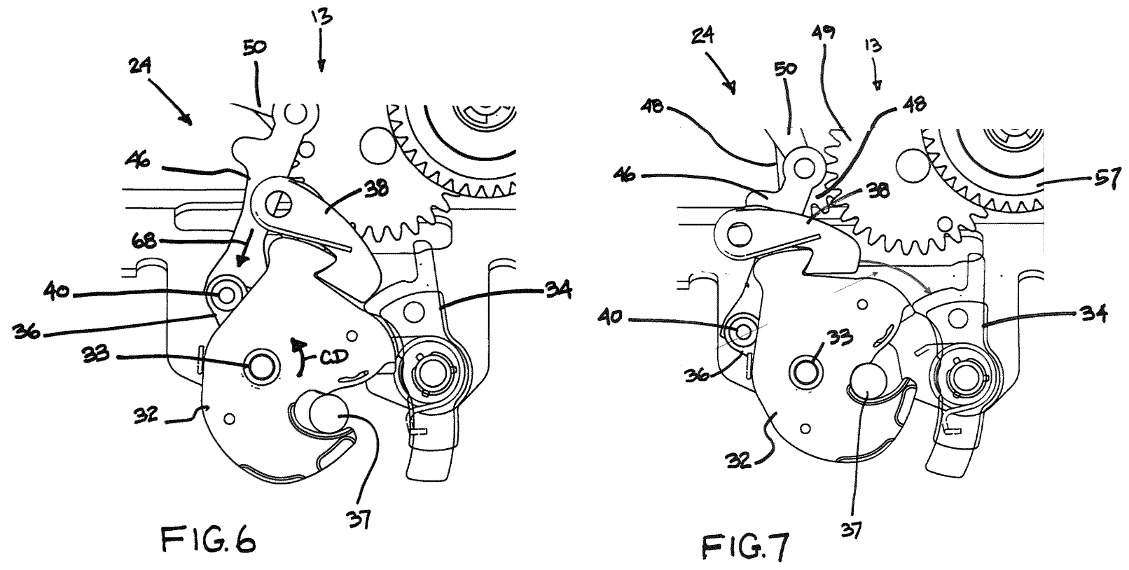

In FIG. 6, while ratchet 32 is in the secondary locking position, a cinching operation can be initiated via selective actuation of electric motor 29. Actuation of electric motor 29 can be automated via one or more sensors configured to detect a desired time for ratchet 32 to be moved to the secondary locking position, with sensor(s) being configured in electrical communication with latch ECU 67, which can signal electric motor 29 to be energized at the desired time. Electric motor 29 is energized to cause worm gear 56 to drive power release gear 57 in a cinching direction (directions discussed here are as viewed in FIG. 13), which in turn causes first pinion gear 57 fixed to power release gear 56 to drive intermediate gear 49 in a counterclockwise direction, which causes second pinion gear 49a fixed to intermediate gear 49 to drive cinch gear 48 in a clockwise direction. As cinch gear 48 is rotated in the clockwise direction, drive lug 54, fixed to cinch gear 48, drives intermediate link 50 in a counterclockwise direction, thereby driving cinch link 46 along a direction of arrow 68 (FIG. 6) and bringing second end 46b of cinch link 46 into driving engagement with ratchet lever pin 40, thereby causing ratchet lever 36 to be driven clockwise, as viewed in FIG. 13, and counterclockwise, as viewed in FIG. 6, about ratchet pin 33. As ratchet lever 36 is driven against a bias of a ratchet lever spring 62 by cinch link 46, auxiliary ratchet link 38 is driven in a counterclockwise direction (FIG. 6) by ratchet lever 36, thereby driving ratchet 32 in a cinching direction CD via hooked engagement of hook end 42 with ratchet tooth 44.

In FIG. 7, the cinching process is shown in an advanced state relative to FIG. 6, showing ratchet 32 rotated to a position just prior to pawl 34 being biased into the primary locking position, also referred to as primary holding position. While ratchet 32 and pawl 34 are in this position, if a loss of power or other issue causing electric motor 29 to stop working, pawl 34 and auxiliary ratchet link 38 can be brought back into engagement with one another, whereat power latch assembly 13 will be maintained in its secondary locking position. It is to be understood that pawl 34 has sufficient strength to withstand a sudden return into forcible engagement with auxiliary ratchet link 38 to withstand being damaged, thereby reliably holding ratchet 32 in the secondary closed position, also referred to as secondary striker capture position.

In FIG. 8, cinch link 46 is continuing to be driven into forcible engagement with ratchet lever pin 40, wherein the cinching process is shown in an advanced state relative to FIG. 7. Pawl 34 is shown moved into the primary locking position, whereat ratchet 32 is in the primary striker capture position.

In FIG. 9, cinch link 46 is shown driven into a maximum forcible engagement with ratchet lever pin 40, with the cinching process shown in an advanced state relative to FIG. 8. Ratchet 32 is rotated past the primary striker capture position such that a locking surface 72 of pawl 34 is moved out from engagement with a primary locking surface 70b of ratchet 32. When brought to this position, electric motor 29 is reversed to return to a home position, whereupon ratchet 32 is allowed to begin movement under the bias of ratchet biasing member 32a toward the striker release position (clockwise as viewed in FIG. 9).

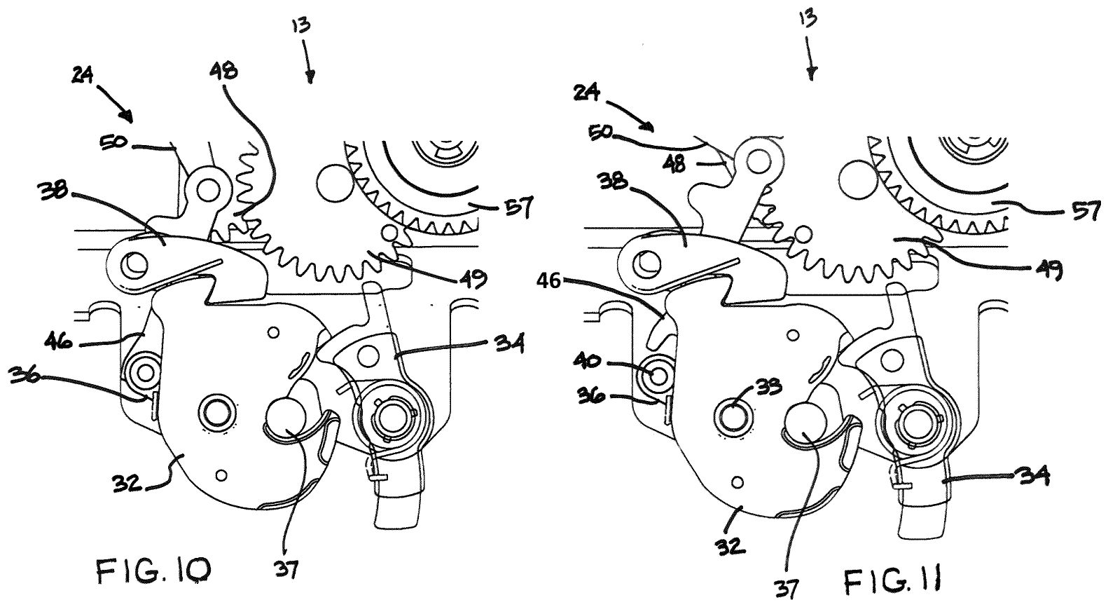

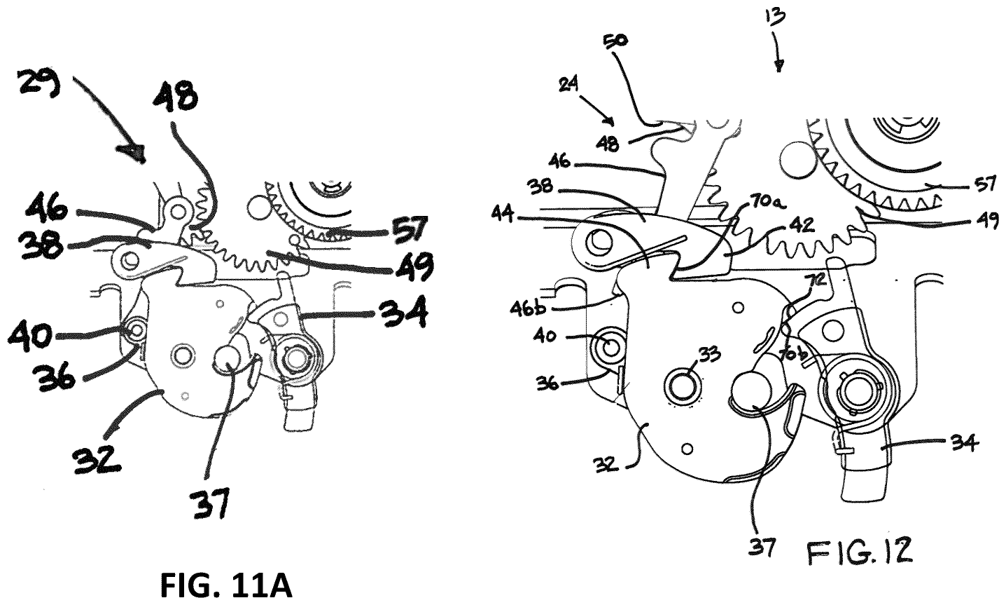

In FIG. 10, electric motor 29 has reversed sufficiently to allow ratchet 32 to return to its primary striker capture position, whereat locking surface 72 of pawl 34 is brought into engagement with the primary locking surface 70b of ratchet 32. In accordance with one aspect, as shown in FIG. 11A, electric motor 29 can be de-energized at this stage, such that the second end 46b of cinch link 46 can remain in contact with pin 40, or in accordance with a further aspect, second end 46b of cinch link 46 can be pivotably coupled to ratchet lever 36 via a pinned connection by pin 40. Otherwise, in another accordance with another aspect, as shown in FIG. 11, electric motor 29 can continue to be backdriven to its home position, whereby moving second end 46b of cinch link 46 out of engagement with pin 40.

In FIG. 12, electric motor 29 is de-energized and power latch assembly 13 is shown in a fully closed position, with ratchet 32 being in its primary striker capture position and pawl 34 in its primary ratchet holding position.

In FIGS. 13-13B, a synchronized release mechanism 30 is illustrated to facilitate moving the power latch assembly 13 to it released, open state. In the non-limiting embodiment, as best shown in FIGS. 13A and 13B, release mechanism 30 includes a cinch disengage lever 30a and a pawl disengage lever 30b, and power release gear cams, referred to as cinch cam 31a and pawl cam 31b, configured for engagement with cinch disengage lever 30a and a pawl disengage lever 30b, respectively, in synchronized relation with one another to cause release of auxiliary ratchet link 38 from ratchet 32 and then release of pawl 34 from ratchet 32. During a power release operation, power release gear 57 is driven in a counterclockwise direction (FIGS. 13-13B), whereupon cinch cam 31a first contacts cinch disengage lever 30a, thereby causing release of auxiliary ratchet link 38 from ratchet 32, and then, as power release gear 57 continues rotation in the counterclockwise direction, pawl cam 31b contacts pawl disengage lever 30b, thereby causing pawl release lever 92 to move pawl 34 to its ratchet releasing position, whereat ratchet 32 is free to move to its striker release position under the bias imparted by ratchet biasing member 32a.

In FIGS. 14 and 15, opposite side views of a power latch assembly 113 in accordance with another aspect of the disclosure are shown, wherein the same reference numerals as used above, offset by a factor of 100, are used to identify like features. Power latch assembly 113 is shown in a fully closed state, also referred to as fully closed position.

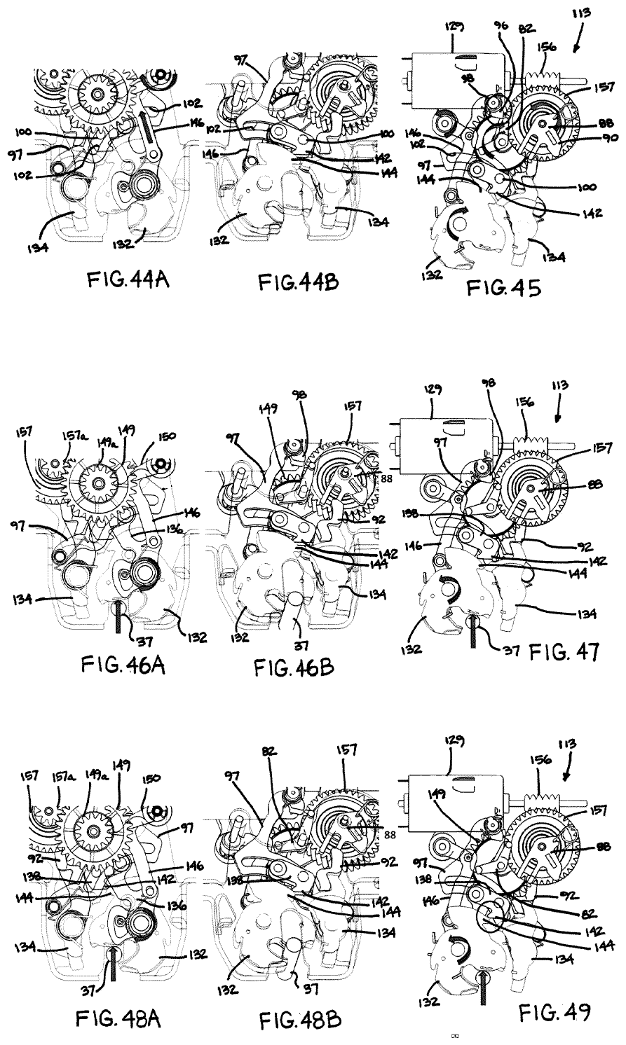

Power latch assembly 113 includes parts as enumerated in FIGS. 14 and 15, including a power release actuator 129, such as an electric motor, for controlling powered actuation of a latch release mechanism 124. Power latch assembly 113 includes a ratchet 132 that is moveable between two striker capture positions about a ratchet axis A1′ defined by a ratchet pin 133. Ratchet 132 pivots about axis A1′ between a primary or fully closed position (shown in FIGS. 14-15, 26, 70A-71), and a secondary or partially closed position (FIGS. 52A-53), whereat ratchet 132 retains striker 37 against being fully released while in both positions. Ratchet 132 is also moveable to a striker release position (FIG. 44A-45), whereat ratchet 132 permits release of striker 37 from a fishmouth 78 provided by a latch housing, also referred to as frame plate 80, of power latch assembly 113. A ratchet biasing member 132a (FIG. 15), such as a spring, is provided to normally bias ratchet 132 toward its striker release position, corresponding to a clockwise direction, as viewed in FIG. 14. A pawl 134 is movable about a pawl axis A2′ defined by a pawl pin 135 (FIG. 3). Pawl 134 pivots about axis A2′ between at least one ratchet holding position whereat pawl 134 holds ratchet 132 in its closed, striker capture position(s), wherein swing door 12 is maintained in a closed state, also referred to as closed position, thereby being restrained against being fully opened, and a ratchet releasing position whereat pawl 134 permits ratchet 132 to move to its open, striker release position, wherein swing door 12 can be moved to a fully open state, also referred to as open position. A pawl/pawl release lever biasing member 134a, such as a suitable spring, is provided to normally bias pawl 134 toward its ratchet holding position.

Power latch assembly 113 has a gear mechanism, also referred to as gear train or multi-stage gear assembly, including a primary drive gear 157, also referred to as power release gear or stage 1 gear, an intermediate gear 149, also referred to as stage 2 gear, and an output drive gear 148, also referred to as cinch gear or stage 3 gear. Each of the stages of the multi-stage gear assembly may be provided with an output or power take off feature which may be formed firstly as part of each gear such as for example a lug or projection, or indirectly coupled to the gear such as for example a driven lever or another gear, as will be described in more detail herein below. In accordance with an aspect of the disclosure, the respective gears 157, 149, 148 of the gear train do not require to be located in a single home position prior to and upon driving components of the power latch assembly 113 to one of a release position, a double lock position, a lock position, and a cinch position. Rather, the primary drive gear 157, and other gears 149, 148 can attain a home position at any location at which they stop upon performing a desired operation/actuation, such as a power release actuation, placing the power latch assembly 113 in a double lock position, placing the power latch assembly 113 in a lock position, and upon performing a power cinch actuation, by way of example and without limitation. In one configuration, the final gear stage 148 may define may define the home positions at the gears opposite end stops. Accordingly, the power release actuator 129 is not necessarily driven from the same location for the same type of operation/actuation.

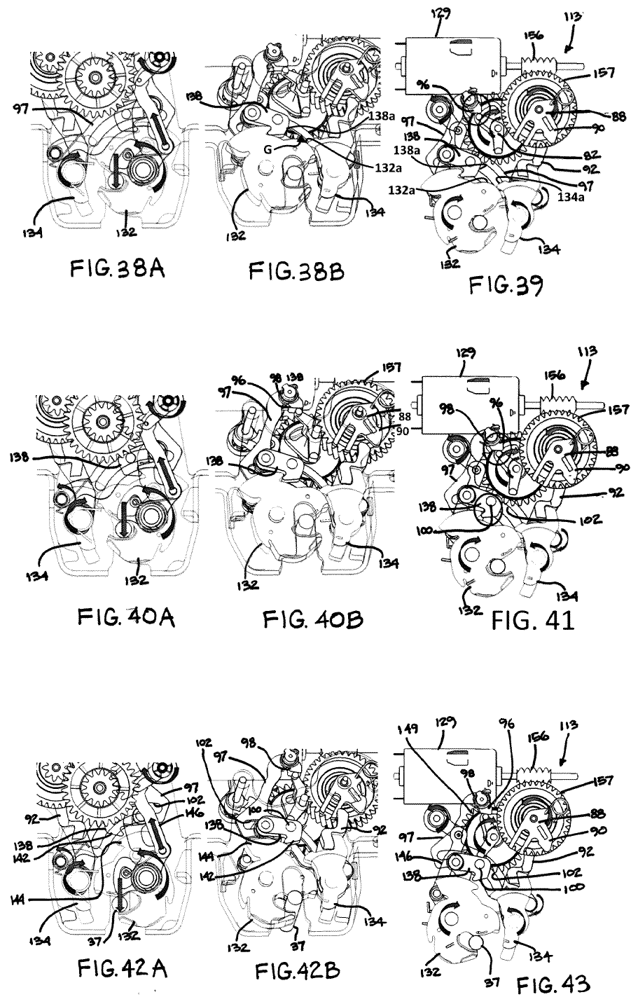

In FIGS. 24-45, a progression of a soft opening cycle of power latch assembly 113 from a closed position to an open position is illustrated, wherein ratchet 132 is moved at a relatively slow speed, compared to a speed if ratchet 132 were allowed to move freely under the bias of ratchet biasing member 132a, controlled by power actuator 129, thus, minimizing the amount of noise generated during release, such as from a seal pop between door 12 and vehicle body 14. In FIG. 24A-25, power latch assembly 113 is closed, and power actuator 129 is de-energized. While in this position, if a load is applied to striker 37 tending to pull ratchet toward a striker release direction, an output stop 74 confronts and prevents movement of a cinch output lever 150 fixed to output drive gear 148, such that output drive gear 148 is maintained in its over-center rest position.

In FIGS. 26A-27, initial actuation of power actuator 129 is illustrated, where, with reference to FIG. 27, power release gear 157 is driven by a worm gear 156 by power actuator 129 in a counterclockwise direction. As power release gear 157 is rotated, a first pinion gear 157a fixed to power release gear 157 drives meshed intermediate gear 149 in a clockwise direction, whereupon a second pinion gear 149a fixed to intermediate gear 149 drives output drive gear 148 in a counterclockwise direction away from output stop 74. Movement of output drive gear 148 causes a cinch mechanism, including cinch output lever 150 to drive a cinch link 146 downwardly, thereby driving a ratchet lever 136 in a clockwise direction (FIG. 26A). As discussed above for ratchet lever 36, ratchet lever 136 is coupled to ratchet 132 via an auxiliary ratchet link 138 having a hook end 142 biased into engagement with ratchet 132 via an auxiliary ratchet biasing member 138a, and having a hook end 142 configured to hooked engagement with a ratchet tooth 144 of ratchet 132. As such, movement of ratchet lever 136 in the clockwise direction (FIG. 26A) causes auxiliary ratchet link 138 to pull ratchet 132 from the primary striker capture position toward an overtravel position against the bias of ratchet biasing member 132a, thereby pulling ratchet 132 away from locked engagement with pawl 134 (FIGS. 28A-29).

During initial movement of power release gear 157, as shown in FIG. 29, intermediate gear 149 is driven in the clockwise direction via a first pinion 157a gear fixed to power release gear 157, and an intermediate gear pin 75, fixed to intermediate gear 149, traverses, in lost motion, a slot 76 in a power release output lever 82. Power release output lever 82 is supported for rotation about an axis defined by a pin 83 about which intermediate gear 149 rotates. As intermediate gear pin 75 engages an end of slot 76, as shown in FIGS. 30B and 31, intermediate gear pin 75 drives power release output lever 82 about pin 83, whereupon a first protrusion 84a extending laterally from a release leg, also referred to as first leg 85a, of power release output lever 82 enters a power release lever slot, also referred to as channel 86, defined by a pair of laterally spaced arms of a Geneva mechanism (understood by a person possessing ordinary skill in the art as a device that transmits continuous rotation of a first device into intermittent rotary movement of a second device), of an auxiliary power release lever 88. Auxiliary power release lever 88 is support for rotation about an axis define by a pin 89 about which power release gear 157 rotates, wherein auxiliary power release lever 88 rotates in a counterclockwise direction in response to be driven by first protrusion 84a.

As intermediate gear 149 is driven in the clockwise direction (FIG. 29), a second pinion gear 149a, fixed to intermediate gear 149, drives output gear 148 in a counterclockwise direction (FIG. 29), thereby causing cinch output lever 150 to drive cinch link 146 along arrow 89, thereby driving ratchet lever 136 in a clockwise direction (FIG. 28A). As ratchet lever 136, also referred to illustratively as a cinch lever, is driven in the clockwise direction, a hook end 142 of ratchet lever 136 pulls a ratchet tooth 144 of ratchet 132, as discussed above for ratchet lever 36 and ratchet 32, thereby rotating ratchet 132 toward the overtravel position out of engagement with pawl 134 (FIG. 29).

Continued rotation of auxiliary power release lever 88 in the counterclockwise direction (FIG. 31) causes a drive arm 90 extending in inclined relation from channel 86 to engage a pawl lever 92 to rotate pawl lever 92 about axis A2 into forcible engagement with pawl 134 to drive pawl 134 away from ratchet 132 in clearance relation therewith.

As shown in FIG. 33, pawl 134 continues to be driven by away from ratchet 132, and cinch link 146 is caused to reverse direction along arrow 89′ by being pulled by cinch output lever 150 as cinch output lever 150 cross over-center. As such, ratchet 132 begins to move from the overtravel position in a release direction.

As shown in FIG. 35, pawl 134 is held away from ratchet 132 by pawl lever 92 via continued engagement between drive arm 90 and pawl lever 92, and cinch link 146 continues to move along arrow 89′ by being pulled by cinch output lever 150. As such, ratchet 132 continues to move in the release direction beyond the primary striker capture position.

As shown in FIG. 37, upon ratchet 132 bypassing the pawl engagement position and continuing to move toward the striker release position, the pawl lever 92 bypasses the auxiliary power release lever 88, whereupon auxiliary power release lever 88 is held in position by a spring member, such as a toggle spring 94.

As shown in FIG. 39, continued rotation of intermediate gear 149 in the clockwise direction brings power release output lever 82 into engagement with an auxiliary disengage lever 96 and a disengage lever 97 (best shown in FIGS. 20A and 20B). Disengage lever 97 is operably coupled to auxiliary disengage lever 96 via a spring member 98, such that spring member 98 transmits torque between the auxiliary disengage lever 96 and the disengage lever 97. As such, a bias imparted on auxiliary disengage lever 96 by power release output lever 82 causes spring member 98 to act on disengage lever 97, whereupon disengage lever 97 acts on auxiliary ratchet link 138, via a slidable pinned connection by a pin 100 disposed for sliding receipt within an elongate slot 102 of disengage lever 97 to move the hook end 142 of auxiliary ratchet link 138 out of engagement from ratchet tooth 144 (transition from FIG. 41 to FIG. 43). As soon as hook end 142 is released from ratchet tooth 144, power actuator 129 is automatically de-energized via recognition by a sensor communication with latch ECU 67 that auxiliary ratchet link 138 is released from ratchet 132, whereat power actuator 129 can remain de-energized until a further power actuated operation is desired. The hook end 142 of auxiliary ratchet link 138 remains biased into engagement with an outer surface of ratchet 132, such that hook end 142 remains positioned to lock with ratchet tooth 144 upon return of the ratchet 132 to a locked position, including the secondary and primary locked positions. With hook end 142 released from ratchet tooth 144, ratchet 132 is free to rotate to the striker release position under the bias imparted by ratchet biasing member 132a (FIG. 45).

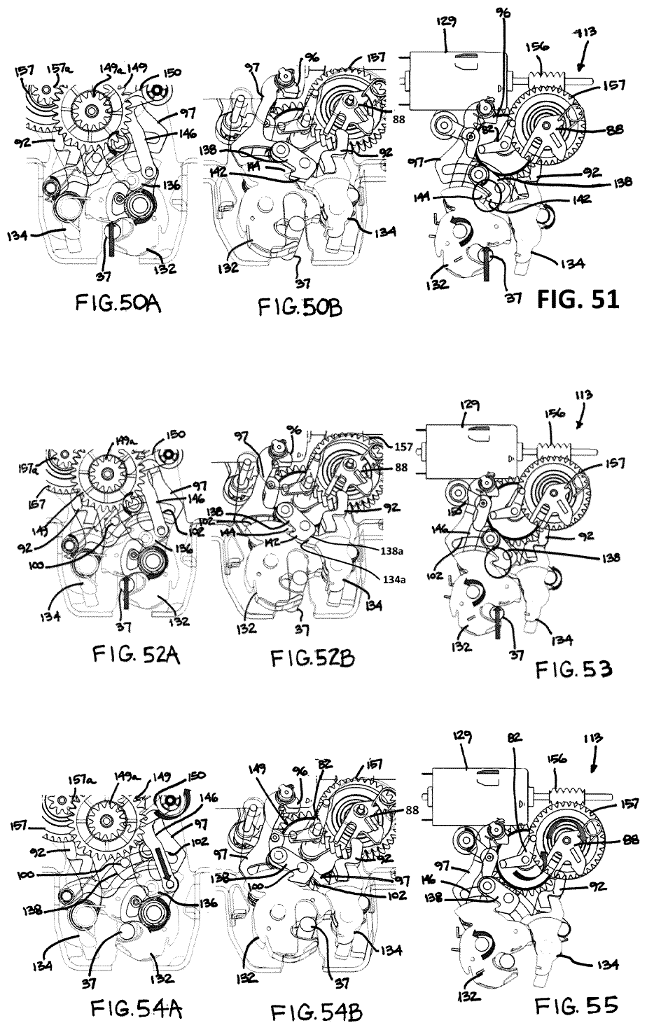

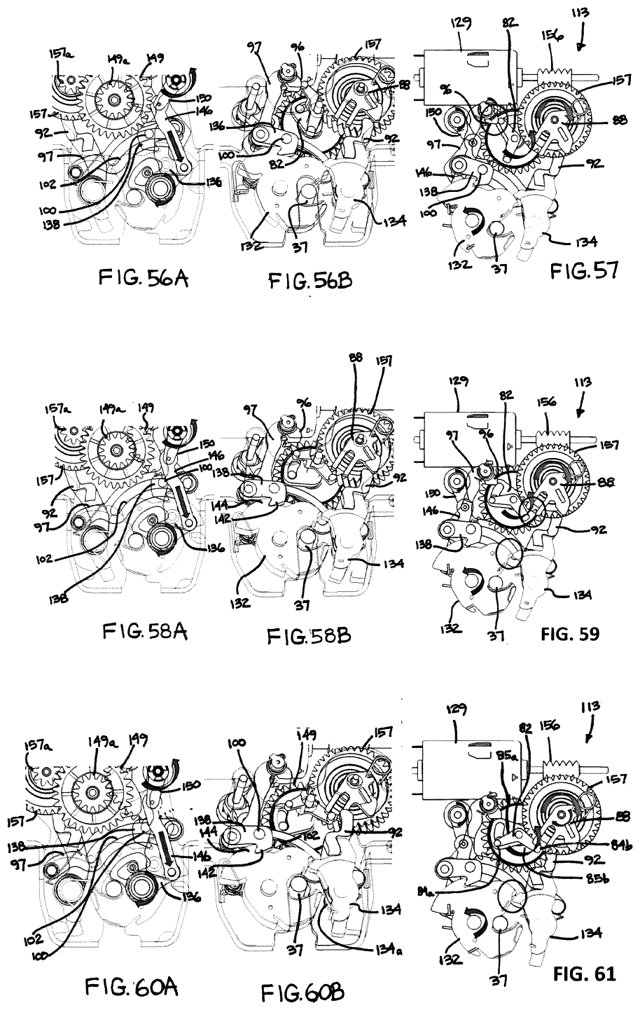

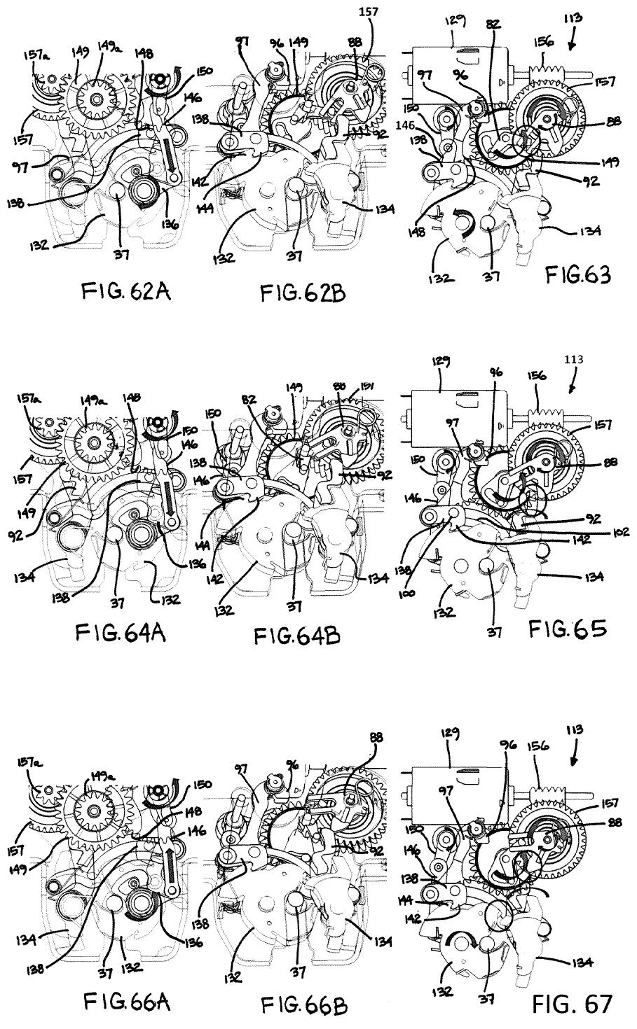

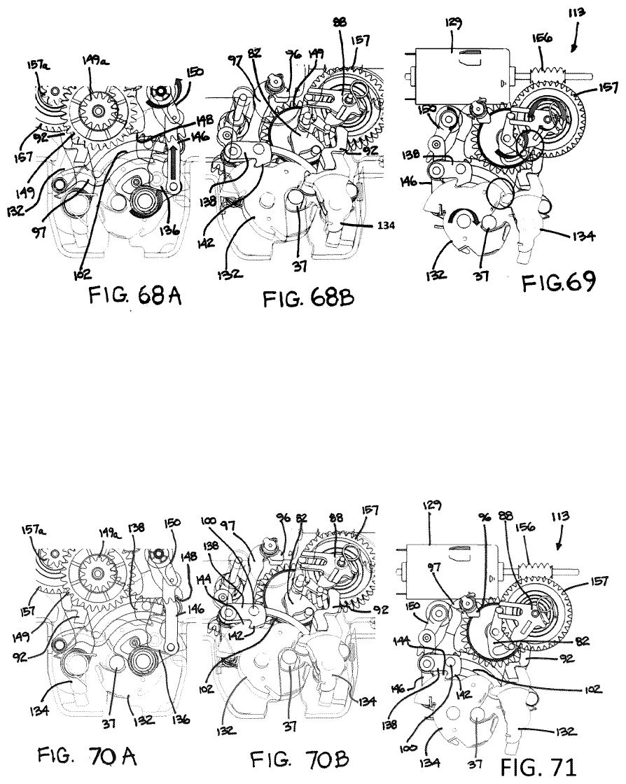

In FIGS. 46A through 71, a cinching operation is progressively illustrated, with the cinching operation beginning in FIGS. 46A-47 with the striker 37 forcibly engaging the ratchet 132 while ratchet 132 is in the striker release position, whereupon ratchet 132 is rotated in a counterclockwise direction such that hook end 142 of auxiliary ratchet link 138 slides along the outer periphery of ratchet 132 toward the ratchet tooth 144 (FIG. 49), until the ratchet 132 reaches the secondary striker capture position, whereat the hook end 142 is brought into hooked engagement with the ratchet tooth 144 (FIG. 53). Having reached the secondary striker capture position, a sensor and/or switch is activated to cause power actuator 129 to be energized.

In FIG. 55, power actuator 129 has been energized in response to a signal from latch ECU 67 to drive power release gear 157 in the clockwise direction. In turn, gear train drives intermediate link 150 in a counterclockwise direction, thereby driving cinch link 146 downward (FIG. 54A) and thus, driving ratchet clockwise (FIG. 54A) from the secondary striker capture position in a cinching direction toward the cinched position.

As shown in FIG. 57, as power release gear 157 continues to drive intermediate gear 149 in a counterclockwise direction, first protrusion 84a of power release output lever 82 drives auxiliary disengage lever 96 in a clockwise direction. Continued rotation of power release gear 157, as shown in FIG. 59, drives ratchet 132 toward the cinched position into the primary striker capture position, whereat pawl 134 drops back into engagement with a primary locking surface of ratchet 132 under the bias imparted by pawl biasing member 134a. At the same, a second protrusion 84b extending laterally from a disengage leg, also referred to as second leg 85b, of power release output lever 82 enters and engages channel 86 of auxiliary power release lever 88 (FIG. 61). As also shown. Continued movement of ratchet 132 toward the cinched position causes ratchet 132 to move past the primary striker capture position to an overtravel position, whereat ratchet 132 moves out of engagement from pawl 134 (FIG. 63) and auxiliary power release lever 88 is automatically cycled to a power release start position via power release output lever 82.

As shown in FIGS. 65 and 67, with ratchet 132 located in it full overtravel position, a spring biased coupling/connection between pawl 134 and pawl lever 92 allows the auxiliary power release lever 88 to bypass the pawl lever 92. As shown in FIG. 67, cinch output lever 150 passes over-center and begins to pull upwardly on cinch link 146, which in turn, causes ratchet 132 to be moved from the overtravel position toward the primary striker capture position. In FIG. 69, auxiliary power release lever 88 has moved beyond pawl lever 92, whereupon pawl lever 92 returns to contact the pawl 134 under the bias of pawl lever biasing member, and thus, power latch assembly 113 is brought to its fully closed position (FIG. 71), with power actuator 129 being positioned for the next desired powered operation without need to be cycled to a different position. Illustratively, as shown in FIGS. 50 to 71, with the cinch lever 138 engaged with the ratchet 132, cinch lever 138 may be in alignment (e.g. radial alignment) with the pawl 134, for example when the pawl 134 is in the ratchet holding position, and/or when the pawl 134 is biased towards the ratchet holding position and may be abutting against an outer surface 132a of the ratchet 132 (for example as seen in FIG. 57) when the pawl 134 is not in a primary holding position. The cinch lever 138 may include a cinch lever surface 138a which may be aligned, such as radially aligned, such that a rotation of the ratchet 132 towards the open position with the cinch lever 138 in engagement with the ratchet 132 may urge the cinch lever 138 to enter into abutting contact against a pawl surface 134a. Rotation of the ratchet 132 causing the cinch lever 138 to be urged into contact with the pawl 132 may be due for example in the event of an abnormality in the cinch cycle e.g. such as a unusual behavior of motor 129 preventing the rotation of the ratchet 132 towards a cinched position against a seal load of a door seal. As a result of a seal load force acting on the ratchet 132 via the striker 37, the ratchet 132 is urged to rotate towards the open position. With the cinch lever surface 138a in alignment with the pawl surface 134a, upon rotation of the ratchet 132 the gap G between the pawl surface 134a and the cinch lever surface 138a is closed and the cinch lever surface 138a is brought into abutment against the pawl surface 134a to prevent further rotation of the ratchet 132, effectively backstopping an inadvertent movement of the ratchet 132 to the open position. Providing the pawl 134 as the supporting backstop structure component for the cinch mechanism benefits from the inherent enhanced strength of the pawl 134 structure and pivot connection of the pawl 134 with the frameplate 80 without the need to form a separate structure, such as providing a separate rivet or projection from the frameplate 80 as non-limiting examples.

In view of the above, and in accordance with a further aspect of the disclosure, a method of controlling a power latch assembly 13, 113 includes: rotating the power release gear 57, 157 using the motor 29, 129 in a first direction away from a first home position to release the power latch assembly 13, 113; ceasing rotation of the power release gear 57, 157 in the first direction following the power release gear 57, 157 reaching a second home position; rotating the power release gear 57, 157 using the motor 29, 129 in a second direction away from the second home position to cinch the power latch assembly 13, 113; and ceasing rotation of the power release gear 57, 157 in the second direction following the power release gear 57, 157 reaching the first home position. Ceasing rotation of the power release gear 57, 157 in the first direction following the power release gear 57, 157 reaching a second home position is in response to detection of a stall condition of the motor 29, 129, and wherein ceasing rotation of the power release gear 57, 157 in the second direction following the power release gear 57, 157 reaching the first home position is in response to detection of another stall condition of the motor 29, 129. As such, ceasing rotation of the power release gear 57, 157 does not occur between the first home position and the second home position.

In accordance with another aspect of the disclosure, rotating the power release gear 57, 157 using the motor 29, 129 in a second direction away from the second home position to cinch the power latch assembly 13, 113 is in response to the ratchet 32, 132 being detected to have moved from an open position to a secondary striker capture position.

In accordance with another aspect of the disclosure, during rotating the power release gear 57, 157 using the motor 29, 129 in a first direction away from a first home position to release the power latch assembly 13, 113, the motor 29, 129 is adapted to cinch the power latch assembly 13, 113 to an overtravel position prior to the motor 29, 129 moving the pawl 34, 134 to a ratchet releasing position.

In accordance with another aspect of the disclosure, during rotating the power release gear 57, 157 using the motor 29, 129 in a first direction away from a first home position to release the power latch assembly 13, 113 after the motor 29, 129 has moved pawl 34, 134 to the ratchet releasing position, the motor 29, 129 is adapted to resist the rotation of the ratchet 32, 132 towards a striker release position.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a motor vehicle, comprising:
a power release actuator arranged to move a pawl from a ratchet holding position, whereat a ratchet is maintained in a striker capture position whereat the ratchet is in latched engagement with a striker to maintain a closure panel in a closed position, to a ratchet releasing position, whereat the ratchet is moved to a striker release position out of latched engagement from the striker to allow the closure panel to be moved from the closed position to the open position;
a cinch mechanism that moves the ratchet from an at least partially released position to the striker capture positon;
a power release gear configured to drive the pawl from the ratchet holding position to the ratchet releasing position, and to drive the ratchet from the at least partially released position to the striker capture positon during a cinching operation, wherein the power release gear does not have a single home position.

2. The power latch assembly of claim 1, wherein the power release gear establishes a home position at an end position of performing any single operation.

3. The power latch assembly of claim 2, wherein the power release gear can move from the home position in either a clockwise or counterclockwise direction to move the ratchet from the primary striker capture position to the striker release position.

4. The power latch assembly of claim 2, wherein the power release gear can move from the home position in either a clockwise or counterclockwise direction to move the ratchet from the secondary striker capture position to the primary striker capture position.

5. The power latch assembly of claim 1, wherein the power release gear is in meshed engagement with an intermediate gear, and the intermediate gear is in meshed engagement with an output gear.

6. The power latch assembly of claim 1, wherein a sensor is not provided to detect the home position of the power release gear.

7. The power latch assembly of claim 1, wherein the power release gear has two home positions.

8. The power latch assembly of claim 1, wherein each of the home positions are defined by the power release gear abutting a hard stop surface.

9. The power latch assembly of claim 8, wherein the power release gear is configured to rotate from a first home position in a first direction to drive the pawl from the ratchet holding position to the ratchet releasing position until the power release gear engages with a first hard stop surface at a second home position, and to rotate from the second home position in a second direction to move the ratchet from an at least partially released position to the striker capture positon until the power release gear engages with a second hard stop surface.

10. The power latch assembly of claim 1, wherein the cinch mechanism is adapted to cinch the power latch assembly to an overtravel position prior to the a power release actuator moving the pawl to the ratchet releasing position.

11. The power latch assembly of claim 10, wherein the cinch mechanism is adapted to resist the rotation of the ratchet towards a striker release position subsequent the moving the pawl to the ratchet releasing position.

12. The power latch assembly of claim 1, wherein the power latch assembly comprises a single motor for controlling the cinch mechanism and the power release gear.

13. The power latch assembly of claim 1, wherein the power latch assembly is adapted to be supported at one of an upper lintel or rocker panel of the motor vehicle for engaging with a striker positioned at respectively the top or bottom of a closure panel.

14. The power latch assembly of claim 1, wherein the cinch mechanism comprises a cinch lever, wherein with the cinch lever in engagement with the ratchet, the cinch lever is in alignment with the pawl in the ratchet holding position.

15. A method of controlling a power latch assembly, comprising:
rotating a power release gear using a motor in a first direction away from a first home position to release the power latch assembly;
ceasing rotation of the power release gear in the first direction following the power release gear reaching a second home position;
rotating the power release gear using the motor in a second direction away from the second home position to cinch the power latch assembly; and
ceasing rotation of the power release gear in the second direction following the power release gear reaching the first home position.

16. The method of claim 15, wherein ceasing rotation of the power release gear in the first direction following the power release gear reaching a second home position is in response to detection of a stall condition of the motor, and wherein ceasing rotation of the power release gear in the second direction following the power release gear reaching the first home position is in response to detection of another stall condition of the motor.

17. The method of claim 15, wherein ceasing rotation of the power release gear does not occur between the first home position and the second home position.

18. The method of claim 15, wherein rotating the power release gear using the motor in a second direction away from the second home position to cinch the power latch assembly is in response to the ratchet being detected to have moved from an open position to a secondary striker capture position.

19. The method of claim 15, wherein during rotating the power release gear using the motor in a first direction away from a first home position to release the power latch assembly, the motor is adapted to cinch the power latch assembly to an overtravel position prior to the motor moving a pawl to a ratchet releasing position.

20. A power latch assembly for a motor vehicle, comprising:
a ratchet;
a pawl;
a cinch mechanism; and
a single motor, the single motor adapted to actuate the pawl to release the ratchet during a power release cycle, actuate the cinch mechanism to cinch the ratchet during a power cinching cycle, actuate the cinch mechanism to cinch the ratchet during a power cinching cycle, actuate the cinch mechanism to cinch the ratchet during a power cinching cycle, and actuate the cinch mechanism to soft open the ratchet during a power soft opening cycle.
